(19) United States
(12) Patent Application Publication
(10) Pub. No.: US 2008/0030497 A1
(43) Pub. Date: Feb. 7, 2008

(54) THREE DIMENSIONAL MODELING OF OBJECTS

(76) Inventors: Yangqiu Hu, Seattle, WA (US); David R. Haynor, Seattle, WA (US); Randal P. Ching, Bellevue, WA (US); Mark A. Ganter, Edmonds, WA (US); William R. Ledoux, Shoreline, WA (US); Duane W. Storti, Seattle, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 11/608,750

(22) Filed: Dec. 8, 2006

Related U.S. Application Data
(60) Provisional application No. 60/748,947, filed on Dec. 8, 2005.

(51) Int. Cl. G06T 15/00

(52) U.S. Cl. 345/419

(57) ABSTRACT

A method is disclosed for segmentation of three dimensional image data sets, to obtain digital models of objects identifiable in the image data set. The image data set may be obtained from any convenient source, including medical imaging modalities, geological imaging, industrial imaging, and the like. A graph cuts method is applied to the image data set, and a level set method is then applied to the data using the output from the graph cuts method. The graph cuts process comprises determining location information for the digital data on a 3D graph, and cutting the 3D graph to determine approximate membership information for the object. The boundaries of the object is then refined using the level set method. Finally, a representation of the object volumes can be derived from an output of the level set method. Such representation may be used to generate rapid prototyped physical models of the objects.

### CROSS-REFERENCE TO RELATED APPLICATION

This application claims the benefit of U.S. Provisional Application No. 60/748,947, filed Dec. 8, 2005, the disclosure of which is hereby expressly incorporated by reference in its entirety.

### STATEMENT OF GOVERNMENT LICENSE RIGHTS

This invention was made with government support under Grant 5P60AR048093-03 awarded by the National Institutes of Health (National Institute of Arthritis and Musculoskeletal and Skin Diseases). The government has certain rights in the invention.

### BACKGROUND

Three dimensional (“3D”) modeling of objects is useful in a wide variety of settings, including modeling anatomical bodies such as bones for research and clinical applications, video animation, and machine and equipment design, to name just a few. Unfortunately, present techniques for producing 3D models are severely limited by the amount of user interaction time involved in creating a 3D model from digital data sets such as 3D voxel data or serial, sequenced two dimensional (“2D”) images. For example, while present techniques allow creation of a 3D digital model from a plurality of 2D images, it is often not cost effective to do so, and the 3D model may not be available fast enough for advantageous deployment. Further, the creation of disarticulated 3D object models from data sets wherein the boundaries between objects are indistinct, due to partial volume effects and noise, currently require tedious user interaction to segment each object.

As a particular example of the need for improved 3D modeling of objects, we consider the applications for such modeling in the medical field. Medical imaging devices may be used to study joint motion; however, processing the acquired images remains a challenging task. Manual segmentation of medical images to identify individual features such as bones is a tedious procedure that also suffers from inter-observer variation, while currently available automatic methods have shortcomings limiting their practical use. For example, one custom software solution, “PolyLines,” works with existing open source image analysis software, “NIH Image,” to produce 3D computer models of anatomical structures, as described in Camacho, D. L. A., Ledoux, W. R., Rohr, E. S., Sangeorzan, B. J., and Ching, R. P. A three dimensional, anatomically detailed foot model: A foundation for a finite element model and means of quantifying foot bone position, Journal of Rehabilitation Research and Development, 39(3), 401-410, 2002. Although such programs and techniques work, the process is highly user-intensive, taking many hours and even days to build models depending on their complexity. Hence, the limiting factor in developing 3D models, both digital and physical, has been the tedious process of generating accurate digital models from the initial digital data.

In the medical field, for example, a useful capability would be to build a rapid prototype of the 3D model of patient-specific anatomical regions in a short period of time. For example, if a patient breaks an ankle, the surgeon could use a rapid prototyped model of the various bone fragments to aid in surgical planning. Rapid prototyping of patient-specific models offers tremendous promise for improved pre-operative planning and preparation, which can not only produce improved patient outcomes, but may improve efficiency and decrease costs by reducing the operating room time requirements. For orthopedic surgeons, the ability to visualize and manipulate a physical model of a bone or joint in need of repair prior to surgery would aid in the selection of surgical implants for fracture fixation or joint replacement. While sizing surgical implants using newer imaging modalities such as Computed Tomography (“CT”) and/or Magnetic Resonance (“MR”) imaging is an improvement over standard X-ray films, the ability to work with an accurate physical model of the region of interest would produce further benefits, providing tactile 3D feedback of the relevant patient anatomy. Other examples of medical specialties that could benefit from the quick availability of patient-specific rapid prototyping include oncology and vascular and craniofacial surgery which could benefit through the improved visualization of tumors, blood vessels, and other patient-specific anatomical structures.

Each year, over 700,000 total hip and knee joint replacement surgeries are performed in the U.S. alone. The sizing of the joint replacement components is largely done using crude templates overlaid on conventional X-ray films. A typical surgeon will then order multiple sets of implants for the operating room to “bracket” the estimated implant size (not unlike a shoe salesperson when we try on shoes). By using patient-specific models for pre-operative planning, the potential time and cost savings associated with these surgeries alone would be substantial and may also free up operating room time producing greater efficiency and perhaps improve clinical outcomes.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In consideration of the above-identified shortcomings of the art, the present invention provides a method for efficiently and accurately segmenting an n-dimensional image data set to identify and digitally model structures imaged in the data set. The method may be applied to image data obtained from any of a wide variety of imaging modalities, including CT, MR, positron emission tomography (“PET”), optical coherence tomography (“OCT”), ultrasonic imaging, X-ray imaging, sonar, radar including ground penetrating radar, and/or acoustic imaging, and the like, and including combinations of imaging modalities. The method is applicable to a wide range of applications from the segmentation of 3D data sets for anatomical structures such as bones and organs, to the segmentation of 3D data sets of mechanical components, archeological sites, and natural geological formations.

The systems and methods described generally contemplate combining a graph cuts method, usually to obtain an initial labeling or membership representation of the data, and a level set method that uses the membership representation as an initial approximation of the structure. The graph cuts method comprises determining location information for the digital data on a 3D graph, and cutting the 3D graph to determine the approximate boundaries of the object. The boundaries of the object may then be refined using the level set method. Finally, a representation of the object's volume can be derived from the output of the level set method. Such representation may be used in rendering the 3D model on a graphical display. It may also be used in generating a physical model of the object. One useful embodiment of the invention comprises deployment to produce rapid prototyped models of anatomical objects, such as bones, for medical study and preparation for medical procedures. Other advantages and features of the invention are described below.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates a flowchart of the segmentation methods described herein;

FIG. 2 is a block diagram showing additional details of the exemplary method illustrated in FIG. 1; and

FIG. 3 illustrates a system for ordering a 3D model of an object, according to the present invention.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

### Overview

In one embodiment, the invention provides an image segmentation method that can create n-dimensional, for example 3D, digital models of objects faster, and more accurately, than prior techniques. The user first obtains an image data set for a region, typically a voxel-based image data set for a 3D region, wherein each voxel encodes at least one image attribute, such as image intensity, color or the like. While the fast image segmentation techniques discussed herein can be deployed in any number of settings, for exemplary purposes the following description focuses on segmentation of anatomical structures such as bones, organs, soft tissue, muscle, and blood vessels from medical images such as CT, MR, PET, OCT, ultrasound images, etc. It will be readily understood by the medical imaging practitioner that the different imaging modalities may be selected depending on the anatomical structure of interest. In particular, the image data from two or more different medical imaging modalities may be combined, for example to improve resolution and/or accuracy, to identify disparate structures simultaneously, and/or to couple functional information with structural information. Known imaging methods may be selected, for example, to identify various soft tissues such as muscles, vasculature, organs including the brain and structures within the brain, and the like. Similarly, imaging methods are known for imaging hard structures, such as bones, dental materials, and foreign structures including those introduced for medical purposes including pins, plates, stents and the like.

The following discussion of the invention in the particular context of rigid anatomical structures such as bones will provide a specific example in which the present method may be usefully deployed, in addition to highlighting novel aspects relating to deployment in this context. It should be clear, however, that the systems and methods disclosed herein may be readily applied in other settings, including applications outside of biological anatomy, for example to identify structures from 3D images derived from industrial applications of CT or X-ray scans, range data, satellite images, digital photographs, geophysics data for geological and oil exploration, sonar data, X-ray imaging data and so forth, and for generating 3D virtual models of mechanical devices.

Image segmentation refers to the delineation and labeling of specific image regions in an image data set that define distinct structures, and may include differentiating a particular structure from adjacent material having different composition, as well as identifying distinct objects having the same or similar composition. For example, in the construction of bone models from CT and/or MR images, bony structures need to be delineated from other structures (soft tissues, blood vessels, etc.) in the images, and in addition each bone must typically be separated from adjacent bones, for example in modeling anatomical structures such as the cervical spine or the foot. The segmentation methods described herein have the capability of separating neighboring bone structures in the image data set, even if the boundaries are indistinct, and under conditions in which the partial volume effect and noise in the images make the problem even more difficult.

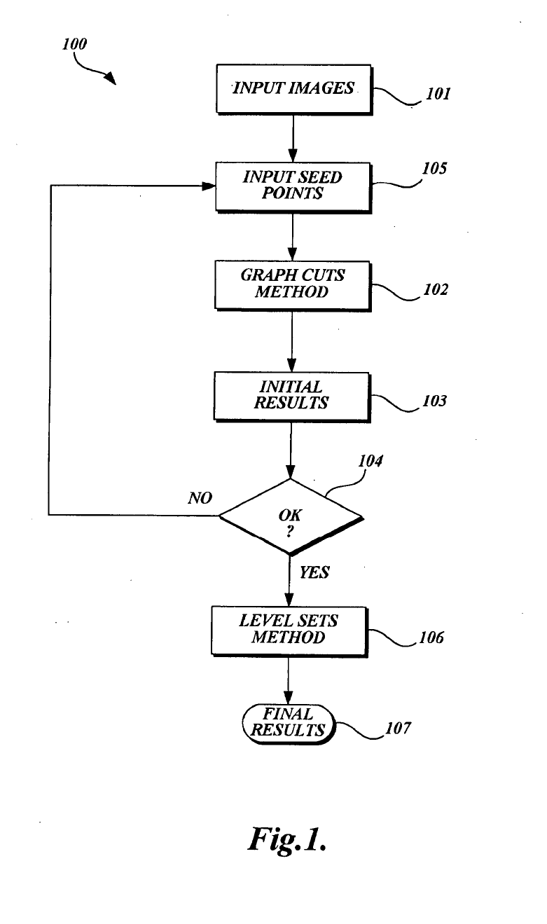

As illustrated in FIG. 1, and described in more detail below, a method is disclosed that uses a graph cuts method to approximately identify image elements or structures in an image data set that correspond to a particular structure such as a bone, and then refines the identification of the particular structure using a level set method.

### Exemplary Graph Cuts Method

An exemplary graph cuts method will now be described, which is somewhat similar to the graph cuts method disclosed in U.S. Pat. No. 6,973,212, which is hereby incorporated by reference in its entirety.

To apply a graph cuts method to the image segmentation problems, a graph is created in which each voxel in the image is represented by a node. One or more object seeds are identified that are members of the object to be identified. Similarly, one or more non-object seeds, or background seeds, are also identified. The object seeds and background seeds may be automatically identified, or otherwise determined from the image data. Two additional nodes are introduced, representing the foreground object (the source node) and the set of non-foreground voxels (the sink node). Connections, or edges, are introduced between neighboring voxels (the n-links) and between each voxel and each of the source node and the sink node (the t-links). Appropriate weights are chosen for the n-links, wherein the weights are small for edges connecting nodes with large intensity difference and large for edges connecting nodes with similar intensity. Appropriate weights are also chosen for the t-links. The current method for choosing the weights is discussed below.

A minimum-cost cut that separates the source node and the sink node may be shown to represent a good partition of the volume into the object and the background. The term “volume” as used herein refers to a 3D geometric entity, as opposed to merely a scalar measure of size. Finding such a cut is a combinatorial optimization problem which has been extensively studied. When there are only two terminal nodes and when some restrictions on graph topology and the selection of the costs are satisfied, algorithms that can efficiently find the global minimum in polynomial time are available to those of skill in the art.

In the present exemplary method, we generally follow the method of Boykov and Jolly for setting up the edge weights, as described below. The weight assigned to the K-links between voxels p and q is: w(p, q)=exp(−d²/σₙ²), where d is the gradient magnitude at the middle point between p and q, and σₙ is a parameter that controls the degree of smoothing. Typically, if p and q are at an object-background boundary, the gradient is large and this weight is small, favoring a cut between p and q. For the object seeds, the weights for their t-links to the source and sink are set to a very large value and zero, respectively, and vice versa for the background seeds. Because the image intensity of bone is not unique on MR images (e.g., the fat can be as bright as the trabecular bone), we set the t-link weights to zero for t-links between non-seed voxels and the source node and between non-seed voxels and the sink node.

Finding the minimum cost cut for the graph structure described above partitions the volume into two disjoint regions. It will be appreciated that to segment out multiple bones the user may run this binary segmentation either simultaneously or sequentially for each bone. When conducted sequentially, each iteration finds one bone. This is achieved by simply modifying the t-links: in each iteration we reassign the t-links while keeping the topology of the graph and the n-links unchanged.

For example, in a current embodiment of the described method, object seed voxels for each bone are first identified from MR image data, and these object seeds are treated as hard constraints. In the current system, axial, coronal, and sagittal plane slices are displayed concurrently on a multi-planar viewer, and correlated by the position of the cursor. The user can identify the object seeds for any bone on any MR slice and in any plane, and the other slices are updated to reflect the object seeds. After selecting seeds for the desired bone, or for all bones, and similarly selecting background seeds, the graph cuts method is applied for each identified bone. In each iteration only the object seeds for the current bone are regarded as the object and the seeds for the background and the other bones are all regarded as background. For example, in an exemplary system, the user can add and/or change the object seeds and background seeds if the segmentation results are not satisfactory. While in this scheme the final segmentation results may depend on the order of bones in which they are processed, experience with the present method has found the difference to be negligible.

The graph cuts method for segmentation is an efficient global method and generally arrives at a segmentation result quickly. The graph cuts method produces a labeling- or membership-type result, wherein individual voxels or the like are determined to either be included as the object, or as a background member. In the present embodiment, the method also has allows the user to interactively refine the result by modifying the seeds, if desired. However, graph cuts methods cannot typically satisfy higher order smoothness constraints.

### Exemplary Level Set Method

A novel aspect of the present method is to combine the generally non-smooth results of a global method, such as the graph cuts method, with a local method such as the level set method, to identify structures in a 3D image data set. The combination of these two methods has been found to provide a computationally efficient method for very accurate segmentation. Level set methods are deformable models that employ implicit and nonparametric representation based on curve evolution theory. In level set methods, a scalar function in a space with one additional dimension is introduced, typically with its zero level set approximately corresponding to the contour of the desired curve or surface in the original space. When the scalar function evolves with time, so does the contour. The evolution of the contour is prescribed by a speed function that combines the influence of the internal and external forces.

In the prior art, parametric models (also known as “snakes”) use a Lagrangian formulation, so they must handle the topology explicitly, which requires special treatment of topological changes in the contour (“reparameterization”). On the other hand, geometric models such as the level set method use an Eulerian formulation, so they can adapt to topological changes automatically. This is a significant advantage over parametric models, especially when the object of interest has a complex shape, as is common for example in anatomical imaging. Another drawback of parametric models is the difficulty to generalize the method to higher dimensions, e.g. from curves in two dimensions to surfaces in three dimensions. By contrast, the present level set method is virtually “dimension-independent” and can be directly extended to any number of dimensions with minor modification due to the intrinsic representation of boundaries. The level set methods have the advantages of using 3D connectivity that is often important for segmenting complex and irregularly shaped 3D objects.

To improve the segmentation result, we apply a level set method on the results obtained from the graph cuts method described above. In a current embodiment of the method, for each bone a fast marching level set method can be first used to convert the region label results, or membership results, obtained from the graph cuts method to initial signed distance function values, which is then taken as the starting input to the level set module. The speed function for the fast marching method is unit everywhere to obtain an approximate distance map. Although the fast marching level set method is currently used, it should be appreciated that this is just one way to obtain initial signed distance function values or map from the segmentation results from the graph cuts method, in order to initialize the level set method refinement step. There are many alternatives for this purpose, such as the Danielsson distance map presented in Erik Danielsson, Euclidean distance mapping, Computer Graphics and Image Processing, 14, pp. 227-248, 1980. Alternatively, repeated application of the level set re-initialization method may be used.

An exemplary speed function for the level set module used in a current embodiment of the present invention is:
F₀(\vec{x})=ω₁·S(|∇G_{σ}[I(\vec{x})]|)·S(I(\vec{x}))+ω₂·κ,

which is the weighted sum of an image-based term (S(|∇G_{σ}[I(\vec{x})]|)·S(I(\vec{x}))) and a curvature term (κ). As will be understood by persons of skill in the art, the image-based term is the product of two sigmoid functions: the first one is a soft threshold on the Gaussian gradient magnitude (|∇G_{σ}[I(\vec{x})]|), and the second one is a soft threshold on the image intensity. In the present embodiment, we use the sigmoid functions of the form:
S(I)=1/(1+exp(−(I−β)/α)),

where the parameters α and β are chosen empirically, for each of the two sigmoid functions. In the present embodiment, the weights (ω₁ and ω₂) are also chosen empirically.

For the bone segmentation application discussed above, the parameters are chosen such that the speed function is large in regions with high bone-like intensity and low gradient, but small in regions with low, non-bone-like intensity or high gradient.

Similar to the graph cuts method, when it is desired to do a segmentation for more than one bone in an image set, the level set method is run separately for each bone. The labels of other bones in the results of graph cuts method are set as a “forbidden region” (e.g., by setting the speed equal to zero) when the contour of one bone is evolving, in order to prevent the final contours of bones from overlapping one another. Since the result from the graph cuts method is usually quite good, in the current embodiment of the method we limit the number of level set iterations to a reasonable number such as 30, although such limitation is not required.

Although different variations of the level set methods may be utilized, the current embodiment of the present invention utilizes the level set method described in A PDE-Based Fast Local Level Set Method, Journal of Comp. Phys. 155, 410-438 (1999), which is hereby incorporated by reference, in its entirety.

### Combining Graph Cuts and Level Set Methods

An exemplary method 100 combining a graph cuts method with a level set method will now be described, with reference to FIG. 1. First, an image data set is obtained or identified, typically by receiving, generating, accessing or inputting one or more images 101, for example by utilizing a medical image data set. The user may then either interactively, or through an automated procedure, determine seed points 105 to represent the bone(s) of interest. The image data set is then processed using a graph cuts method 102 to obtain an initial labeling of nodes corresponding to the identified bone(s). As discussed above, the user may view initial results 103 and add, delete, and/or modify the seed points 105 and rerun the graph cuts method 102. When satisfactory results are achieved, the user may indicate the results are satisfactory 104. Of course, the process of adjusting the seed points and/or determining when satisfactory results are achieved may be readily automated, for example by selecting a suitable criteria for satisfactory results such as convergence to a result and/or satisfying smoothness constraints.

The image data set defined by the image(s) identified in 101 may comprise image data from any of a variety of imaging methods or combination of methods. For example, the image data set may comprises a plurality of 2D images of an object, MR images, and/or CT images. Some CT, MR, or other devices gather digital data in a helical dataset or other 3D dataset such as those gathered by seismometers, rather than a 2D image. Such a helical dataset or other 3D dataset is also considered digital data that can serve as an input image. For other applications, including non-anatomical applications, the image data may comprise image data obtained using ultrasound, sonar, radar, PET, or any other imaging modality.

In the second stage of the method 100 shown in FIG. 1, a level set method 106 is performed using the initial results 103 from the graph cuts method 102. The final results 107, which is initially in the form of refined signed distance function values, may include further processing, for example to translate the data into a form more suitable for display or fabrication, as discussed below. It will be understood that “signed distance function values” as used herein is intended to include approximate signed distance function values including discretized signed distance function values. As discussed, the level set method 106 will typically require a number of iterations during with the optimal contour results will evolve. It is contemplated that the parameters for the speed function for the level set method may be derived from the statistical properties of the intensities in the image data.

In the level set method framework, every bone is denoted by a contour, and the method may be applied in parallel for all identified bones, such that all of the contours may evolve simultaneously. The contours compete with one another during the evolution to ensure they will not overlap. This competition between near-adjacent bones may be optimized by modulating the relevant speed functions when two contours get close to each other. The graph cuts method segmentation tries to find the labeling that is globally optimal, and is therefore relatively insensitive to the seed points that the user selects. In addition, because of its fast implementation, the method allows the user to immediately see the results. On the other hand, level set method segmentation works locally and usually requires good initialization. Because of the continuous nature of partial differential equations and the effect of curvature constraint, level set method segmentation tends to produce more accurate results that also adhere to local boundaries better than graph cuts method segmentation, given good initialization.

The final results identified in 107 can comprise a data output of the level set method 106, or may comprise a 3D digital model of an object in a format that requires additional processing to compute. Such additional computation derives a representation of an object's volume from an output of the level set method 106. For example, an output of the level set method may be converted into a widely used file format for viewing 3D digital models such as virtual reality modeling language (VRML), X3D, Java3D, 3DMF, nonuniform rational b-splines or others. The object may be any object, such as a chair, table, automobile, and so forth. In the medical setting the object may comprise organs, bones, and the like.

The disclosed method for creating a 3D digital model of an object may be applied simultaneously to a plurality of objects in a given image data set. For example, a plurality of seed points may be chosen in 105 for the various bones in a human ankle. The graph cuts method may then proceed to locate approximate boundaries of all bones simultaneously. Once the initial results 103 are approved 104, the level set method 106 may then also operate simultaneously on all bones.

Simultaneous application of the methods is considered preferable in some settings, for example where there is ample computer memory available for simultaneous processing. In settings with less available memory, as will be identifiable by those of skill in the art, it may be preferable to apply the graph cuts method and/or the level set method serially. Serial processing comprises applying the graph cuts method 102 to a first object, then a second object, and so forth. Upon approval, the level set method 106 may be likewise applied serially to a first object, a second object, and so forth.

Regardless of whether graph cuts method 102 and/or the level set method 106 is applied simultaneously or serially, an advantage of the invention is its power in generating disarticulated representations of a plurality of objects. For example, the bones in an ankle can be identified as separate entities within a 3D digital model, can be separately manipulated for viewing, and/or individual physical models can be generated. This allows visualization of some of the modeled 3D objects while others remain hidden, for example, by making them transparent in a digital model, and physical 3D models of disarticulated objects may be produced.

It will now be appreciated that embodiments of the present invention that employ the exemplary two-stage segmentation strategy combine the advantages of the graph cuts method and the level set method while avoiding their disadvantages. The present inventors have applied the techniques described herein to the segmentation of a spine from CT images, and to segmenting foot bones from CT and MR images, with uniquely advantageous results in terms of speed and accuracy. The accuracy of the results from our method is comparable to fully manual segmentation results, but requires only a small fraction of the user operation time. Some exemplary samples of the application of the present method are illustrated in the related provisional patent application No. 60/748,947, which is hereby incorporated by reference in its entirety.

Although the method 100 is believed to provide advantages over the prior art in the medical field, it is clearly applicable in a wide variety of other applications. For example, the method has also been applied successfully by the inventors to segmenting components visible in an image data set of an internal combustion engine.

### More Detailed Overview of Current Embodiment

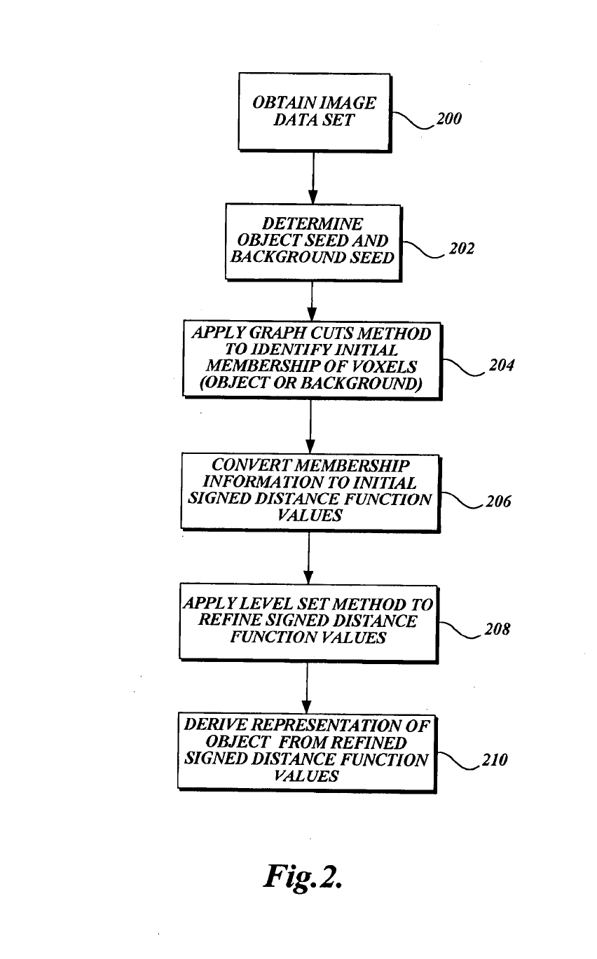

Additional details of the current implementation of the method described above is shown in the block diagram shown in FIG. 2. The method begins with obtaining one or more image data sets 200 that are to be processed. As discussed, the image data sets may come from any convenient imaging modality, or combination of modalities, and are typically in the form of planar or voxel arrays (regular or irregular) of data. Often the data comprises an image intensity value, although other data types such as color, or the like may be used.

One or more object seeds and background seeds are then determined 202. The determination of the seed values may be done manually or automatically. A graph cuts method is then applied 204, to identify the voxel initial membership as either object nodes or background nodes. The image data set may include more than one object of interest, and the graph cuts method may be applied either serially or in parallel to obtain voxel initial memberships for each object of interest. The initial membership information is then converted to initial signed distance function values 206, which may conveniently be accomplished using a fast marching method, such as a fast marching level set method. A level set method is then applied 208, using the initial signed distance function values as a starting point, and the signed distance function values are thereby refined. The level set method is typically iterated a number of times (which may be a fixed number, or may be dependent on the outcome, for example quitting upon meeting a minimum value on a measure of the change in the signed distance function over an iteration.) Finally, the final refined distance function values are typically converted to a representation suitable for display or other processing 210, for example by generating a surface representation of the surface of the object. The surface representation might be any standard representation suitable for subsequent display or processing, including polygonal meshes, non-uniform rational b-splines (“NURBS”), spatial occupancy, potential functions, or the like.

### Extension to n-Dimensional Data

Although the present method has been described with reference to segmentation of 3D image data sets for purposes of best explaining the method, it will be immediately apparent to persons of skill in the art that the methods described above are readily applicable to any number of dimensions. It is contemplated that the methods may be applied to n-dimensional data, where n may be 2, 3, 4 or a larger number. In particular, it is contemplated that the invention may be applied to n-dimensional data wherein one of the dimensions is time, and including two or three spatial dimensions, for example to use the segmentation method to identify structures that evolve over time or to capture the motion of structures, e.g., a time-sequence image data set. The benefits to applying the disclosed method to a time-sequence image data set, for example images obtained using functional magnetic resonance imaging, may include improved accuracy, shorter calculation time, lower computational costs, and the ability to view the segmentation data in novel ways.

It should also be appreciated that the present method greatly reduces the time required for segmentation of an n-dimensional data set, including a 3D data set, and therefore applications such as the ability to produce animated sequences of data from time-sequence image data sets, to show motion becomes much more practical. For example, time-sequence 3D image data of a chest containing a beating heart may be processed using the method described above, in reasonable computational times, to generate a detailed animation of the motion of the beating heart.

### Generating a Physical Model Corresponding to the 3D Digital Model

A contemplated application of the method described above is to produce a physical model of structure(s) identified from the segmentation of the image data set. Generating a physical model corresponding to the 3D digital model may be accomplished, for example, using a rapid prototyping process. Rapid prototyping refers to a collection of technologies for producing physical parts directly from digital descriptions, frequently the output from Computer-Aided Design (CAD) software, but potentially the output of any software for producing a 3D digital model. Rapid prototyping machines have been commercially available since the early 1990's, and the most popular versions involve adding material to build the desired structure layer-by-layer, based on a digital three dimensional model of the structure.

For example, a physical model may be fabricated, for example using a rapid prototype system, for example using stereolithography, fused deposition modeling, or three dimensional printing. Stereolithography involves using a laser to selectively cure successive surface layers in a vat of photopolymer. Fused deposition modeling employs a thermal extrusion head to print molten material (typically a thermoplastic) that fuses onto the preceding layer. Three dimensional printing uses a print head to selectively deposit binder onto the top layer of a powder bed.

While all of the above described rapid prototyping systems build an object by adding consecutive layers, as opposed to subtractive rapid prototyping or conventional machining that uses a tool to remove material from blank stock, the generation of a physical model may just as well use such other processes and equipment. For example, rapid prototyping processes may be adapted to produce functional objects (“parts”) rather than just geometric models. On this basis, rapid prototyping is also referred to by the alternative names additive fabrication, layered manufacturing and solid freeform fabrication.

Therefore, the methods described above may be combined with technologies for rapid prototyping a 3D model, as well as software and user interfaces for controlling such technologies. With additive fabrication, layered manufacturing, or solid freeform fabrication a wide range of parts can be produced. Traditional limits associated with cutting tool access and curvature are no longer relevant. Multiple parts can be built at once, and a specified geometric relation can be maintained by retaining support structures between the individual parts. Alternatively, the supports can be removed so that working mechanisms can be produced in a single build operation. Depending on the machine, support structures may be removed manually or dissolved, for example by running the parts through a dishwasher like system.

Rapid prototyping machines and corresponding control software can print parts in color, including surface text to produce annotated parts, from 3D digital models. It is increasingly possible to build parts with variable composition. Since the part is built up layer by layer, the fabrication system has access to the interior of the part to produce internal material variations and to include internal structures. The techniques provided herein can be used with any processes or machines for building a physical model, whether presently in use or later developed.

Many commercial rapid prototyping machines currently employ standard input formats comprising of a polygonal representation of the boundary of the object. For example, a CAD model or other 3D digital model is converted to a list of triangles lying on the surface of the object and the machine slices through the collection of triangles to determine the boundary for each layer to be deposited.

While such an input standard may not make full use of 3D objects modeled with high accuracy using the techniques described above, accurately modeled 3D objects may be converted into an appropriate input standard as necessary to interface with existing or developed rapid prototyping technologies.

With reduction in time required to produce 3D digital models, and corresponding reduction in overall time for producing a rapid prototyped physical model, it is envisioned that patient-specific anatomical models will enable surgeons to “see and feel” human anatomy they will be operating on, either digitally on a computer screen or physically through the use of rapid prototyping, prior to making an incision, thus potentially reducing surgical time.

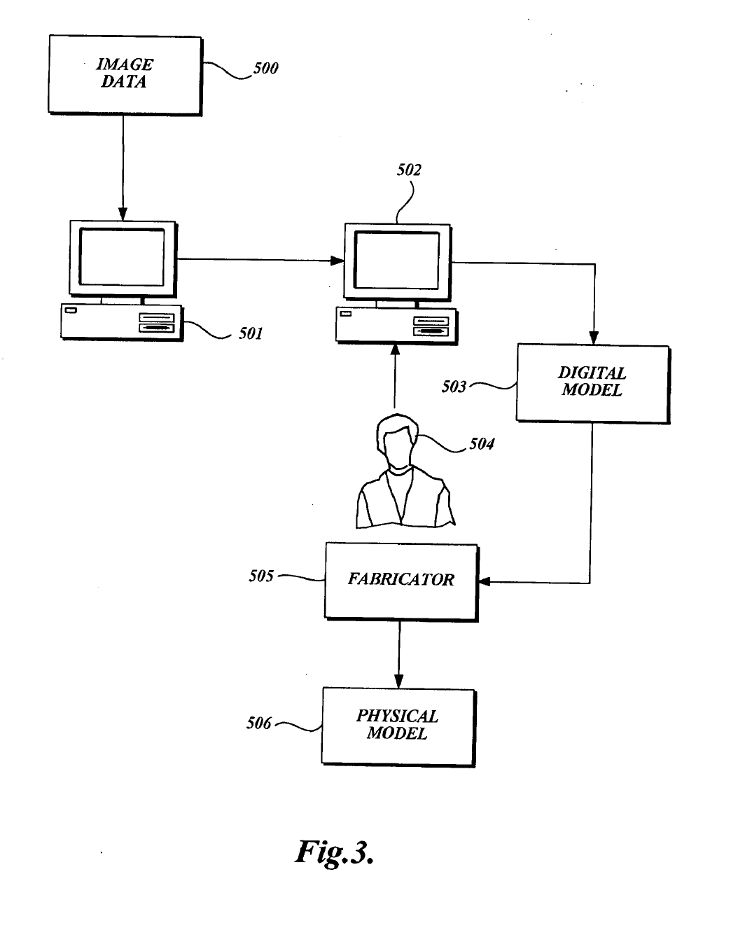

FIG. 3 illustrates an exemplary system for ordering a 3D model, either digital or physical. The model can be, for example, a patient-specific anatomical model. First, medical image data 500 such as CT, MR, etc, is provided to a computer 501. A user at the computer 501 selects, for example, to generate a 3D model, and thereby causes the computer 501 to send digital data to a networked computer 502. The networked computer 502 has loaded thereon programs for producing a 3D digital model 503 of an object identifiable in the image data 500, in accordance with the description provided herein. A technician 504 may then choose appropriate seed points in the images received seed points are automatically selected, as discussed above, and the segmentation procedure is started.

Once the 3D digital model 503 is produced, the computer 502 sends the digital model 503 to a fabricator 505 for producing a physical mode 506. The fabricator 505 may comprise, for example, a rapid prototyping device as discussed above. The resulting physical model 506 produced by the fabricator 505 may be delivered back to the location from which it was ordered, or to some other specified address. The 3D digital model 503 may also be delivered electronically back to the computer 501 or to another networked computer (not shown), for example a computer in a doctor's office or operating room, at which surgeons can investigate the 3D digital model 503 prior to or during surgery.

### Exemplary Embodiments for Studying Object Morphology and Kinematics

Various embodiments of the invention may be used to study object morphology and kinematics. For example, an embodiment of the invention uses an MR-compatible loading device to scan a foot in a single neutral position and in seven additional positions progressing from plantar flexion, internal rotation and inversion through neutral to dorsiflexion, external rotation and eversion. A segmentation method combining a graph cuts method and a level set method, as described above, allowed a user to interactively delineate bones in the neutral position volume with significantly less user interaction and total processing time than previous systems.

In the subsequent registration step, a separate rigid body transformation for each bone was obtained by registering the neutral position to each of the additional positions, which produced an accurate description of the motion between them. The image segmentation and registration method disclosed herein may thus be beneficially applied to studying object morphology, e.g. joint morphology, and kinematics from digital data, e.g., in vivo MR imaging scans.

For the ankle application the present method has been used to delineate bones in the baseline (neutral) scan: tibia, fibula, talus, calcaneus, navicular, cuboid, medial, intermediate, and lateral cuneiforms, and first through fifth metatarsals. The segmentation step breaks a joint into a collection of individual bones, so rigid body registration can be used for each bone separately to follow its motion across multiple scans. Mutual information maximization is used to estimate the transformation parameters. For example, a starting point for registration may be selection of two roughly corresponding points from the scans to be registered, one in each position.

The use of intensity-based image registration requires segmentation in only one position, which also significantly reduces the amount of user interaction. To process a foot scanned in eight positions our method can currently be carried out within about thirty minutes of user interaction time, which is significantly less than the time required for existing systems, and is an improvement that has the potential to make joint motion analysis from MR imaging practical in research and clinical applications.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims. For example, the present method has been applied with success and/or is believed to be suitable for segmenting images to identify structures such as ligaments, cartilage, tendons, muscles (including the heart), vasculature, teeth, brain, tumor tissues, and the like. The method of the present invention may also be used to segment in anatomical images foreign matter such as screws, plates and prosthetics.

The present method has also been used to image and segment non-anatomical subjections, including an engine block. Clearly, the method may also be applied to images of non-human anatomy.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for image segmentation comprising:
obtaining an image data set of a three dimensional region, the image data set comprising a plurality of voxels, each voxel having an image attribute;
determining an object seed in the image data set for a first structure in the image data set, and a background seed outside the first structure in the image data set;
applying a graph cuts method to identify initial membership data of voxels in the first structure;
converting the initial membership data into initial signed distance function values;
applying a level set method initialized with the initial signed distance function to generate refined signed distance function values to identify the first structure; and
deriving a representation of the first structure from the refined signed distance function values for the first structure.

2. The method of claim 1, wherein the image data set comprises images of the three dimensional region obtained using one or more imaging modalities selected from magnetic resonance imaging, computed tomography, ultrasound, X-ray imaging and positron emission tomography.

3. The method of claim 1, wherein the image attribute is intensity.

4. The method of claim 1, wherein the step of converting the initial membership data into initial signed distance function values is accomplished using a fast marching level set method.

5. The method of claim 1, wherein the derived representation of the first structure is a representation selected from a polygonal mesh and a non-uniform rational b-spline.

6. The method of claim 1, further comprising the steps of determining an object seed in the image data set for a second structure in the image data set, applying a graph cut method to identify initial membership data of voxels in the second structure, converting the initial membership data for the second structure into initial signed distance function values identifying the second structure, applying a level set method to generate refined signed distance function values, and deriving a representation of the second structure from the refined signed distance function values.

7. The method of claim 1, wherein the image data set includes a time-sequence data set.

8. The method of claim 1, further comprising fabricating a physical model of the first structure using the derived representation of the first structure.

9. The method of claim 8, wherein the physical model of the first structure is fabricated using a rapid prototyping system.

10. A method for image segmentation comprising:
obtaining an n-dimensional image data set of a region comprising a plurality of voxels containing at least one image attribute;
applying a graph cuts method to identify a boundary of a first n-dimensional object in the region; and
converting the boundary identified by the graph cuts method to initial distance function values;
applying a level set method using the initial distance function values to refine the boundary of the first n-dimensional object.

11. The method of claim 10, wherein the n-dimensional image data set is a three dimensional image data set.

12. The method of claim 10, wherein the region is an anatomical region.

13. The method of claim 10, wherein the at least one image attribute comprises image intensity.

14. The method of claim 10, wherein the graph cuts method includes the steps of:
introducing a source node and a sink node;
determining at least one object seed node from the plurality of voxels identifying the first n-dimensional object;
determining at least one non-object seed node from the plurality of voxels identifying a region outside the first n-dimensional object;
introducing n-links between neighboring voxels;
introducing first t-links between each object node and the source node;
introducing second t-links between each voxel and the sink node;
selecting relatively small weights for n-links connecting voxels with a large intensity difference, and selecting relatively large weights for n-links connecting voxels with a small intensity difference;
setting the weights of first t-links to zero;
setting the weights of second t-links to a very large value; and
calculating a segmentation cut having the smallest total cost of all cuts separating said source node from said sink node.

15. The method of claim 11, wherein the first three dimensional image data set comprises image data from a plurality of medical images obtained using one or more imaging modalities selected from magnetic resonance imaging, computed tomography, ultrasound, X-ray imaging and positron emission tomography.

16. The method of claim 11, wherein the first three dimensional object comprises a bone.

17. The method of claim 12, further comprising the steps of:
applying a graph cuts method to identify a second boundary of a n-three dimensional object in the anatomical region;
converting the results from the graph cuts method to initial distance function values for the second n-dimensional object; and
using the initial distance function values, applying a level set method to refine the boundary of the second n-dimensional object.

18. The method of claim 10, further comprising the step of generating a physical model of the first three dimensional object using a rapid prototyping process.

19. The method of claim 17, further comprising the steps of:
obtaining a second three dimensional image data set of the anatomical region after the first three dimensional object is moved with respect to the second three dimensional object;
using rigid body registration to segment the first and second three dimensional objects in the second three dimensional image data set.
